(19) United States
(12) Patent Application Publication
(10) Pub. No.: US 2016/0369521 A1
(43) Pub. Date: Dec. 22, 2016

(54) APPARATUS AND METHOD FOR SECURING AN ELONGATED OBJECT WITHIN A FISHING ROD HOLDER ON A BOAT

(71) Applicant: Robert J. Eldridge, St. Augustine, FL (US)

(72) Inventor: Robert J. Eldridge, St. Augustine, FL (US)

(21) Appl. No.: 15/180,174

(22) Filed: Jun. 13, 2016

Related U.S. Application Data
(60) Provisional application No. 62/180,658, filed on Jun. 17, 2015.

(51) Int. Cl. E04H 12/22; G09F 17/00; A01K 97/10

(52) U.S. Cl. CPC E04H 12/2269; A01K 97/10; G09F 17/00; G09F 2017/0075

(57) ABSTRACT

A securing device anchors a flag pole inside a boats rod holder so the boat can operate while flying a flag. The securing device includes an elongated cable, preferably including a protective sheathing, with a securing device such as an eyelet connector at one end for connecting to a flag pole, and a hooking device such as a snap hook at the other end. The device detachably connects a flag pole to the cross bar of a boat's rod holder.

### CROSS-REFERENCE TO RELATED APPLICATIONS

This application claims priority from the United States provisional patent application entitled APPARATUS AND METHOD FOR SECURING AN ELONGATED OBJECT WITHIN A FISHING ROD HOLDER ON A BOAT, which was filed on Jun. 17, 2015, and assigned the Ser. No. 62/180,658.

### BACKGROUND OF THE INVENTION

Field

The present invention relates to securing hardware, and more specifically, to an apparatus and method for securing an elongated object such as flag pole within a fishing rod holder on a boat.

Related Art

Many boaters have fishing rod holders affixed to their boat. These holders typically have a cylindrical body with an open top end, and a semi-closed bottom end, and a means for attaching the cylindrical body to the boat. In conventional use, one will insert the handle end of a fishing rod into the open top end, and the fishing rod handle will come to rest on the semi-closed bottom end. Gravity holds the rod in place.

Oftentimes boaters will insert elongated objects other than fishing poles into their fishing rod holder, for example flag poles. This allows a boat operator to “fly a flag” while operating their boat.

Unfortunately, however, unsecured elongated objects such as flag poles can fly out of fishing rod holders. This is especially likely to happen when there is wind, the boat is being driven, and/or the water is choppy. An object flying out of a rod holder unexpectedly is potentially very dangerous.

As can be seen, there is a need for a device that can retain an elongated object within a fishing rod holder. It is preferred that this device is simple, easy to use, inexpensive to manufacture and transport, and lends itself to printing so as to be used as an advertising vehicle.

### SUMMARY OF THE INVENTION

The present invention pertains to a securing device that attaches at one end to a flag pole, and at the other end to the cross bar of a boat's rod holder. The device allows a user to insert a flag into a rod holder and operate the boat without the risk of the flag flying out of the holder.

The securing device is an elongated cable, preferably including a protective sheathing, with a securing device such as an eyelet connector at one end for connecting to a flag pole, and a hooking device such as a snap hook at the other end for connecting to a rod holder's cross bar.

### BRIEF DESCRIPTION OF THE DRAWINGS

FIG. 1 is a perspective view of a flag pole inserted in a rod holder on a boat;

FIG. 2 is a perspective view of an embodiment of the device attached to a flag pole;

FIG. 3 is a perspective view of an embodiment of the device attached to a flag pole being inserted into a rod holder;

FIG. 4 is a perspective view of an embodiment of the device attached to a flag pole inserted in a rod holder, and attached to the cross bar of a rod holder;

FIG. 5 is a close-up perspective view of the bottom end of a rod holder depicting a flag pole inserted and an embodiment of the device attached; and

FIG. 6 is an alternative embodiment of the device, and a screw as a securing means.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. For example, as used herein a flag pole is used as the exemplary elongated body, but other structures such as fishing rods could also be secured using the present invention.

The following structure numbers shall apply to the following structures among the various FIGS.:
10—securing device;
15—cable;
20—sheathing;
25—snap hook;
35—eyelet connector;
40—clamp;
50—rod holder;
55—cross bar;
60—flag pole; and
65—screw.

Broadly, securing device 10 includes a section of cable 15 with eyelet connector 35 at a first end, and hook 25 at a second end. The eyelet connector releasably retains a securing means, for example screw 65, to connect flag pole 60 to securing device 10. Hook 25 releasably attaches securing device 10 to cross bar 55 of rod holder 50.

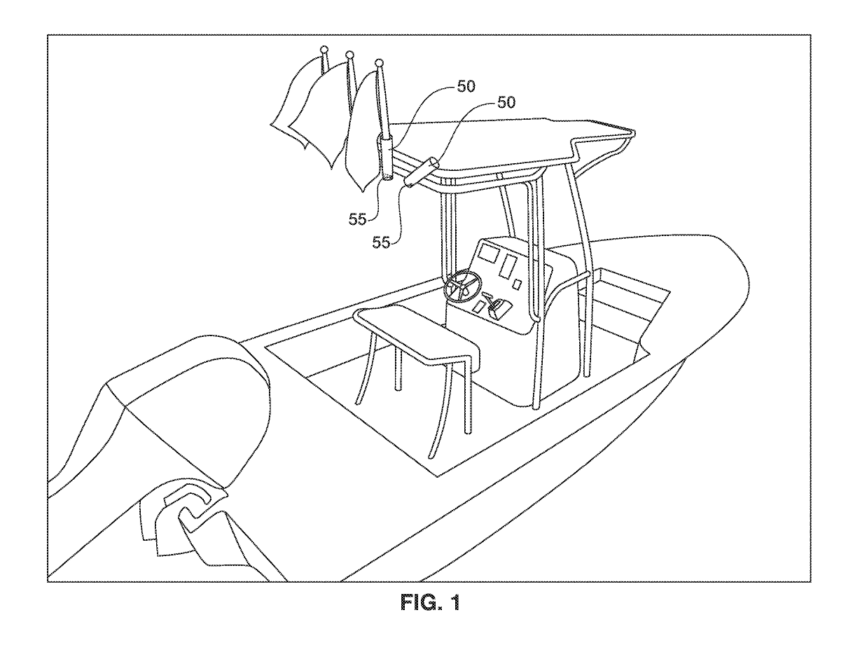

FIG. 1 depicts a boat having two rod holders 50, one of which has a flag pole inserted within.

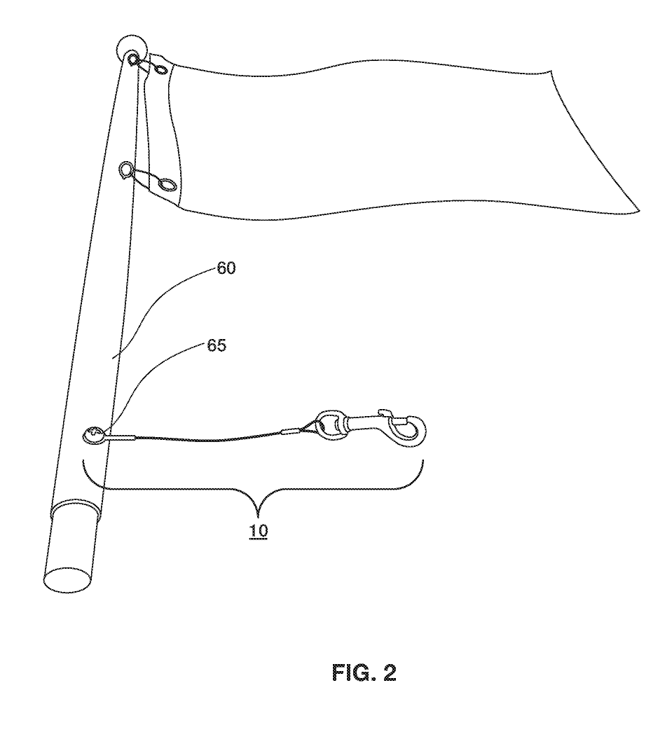

FIG. 2 is a flag with securing device 10 attached thereto.

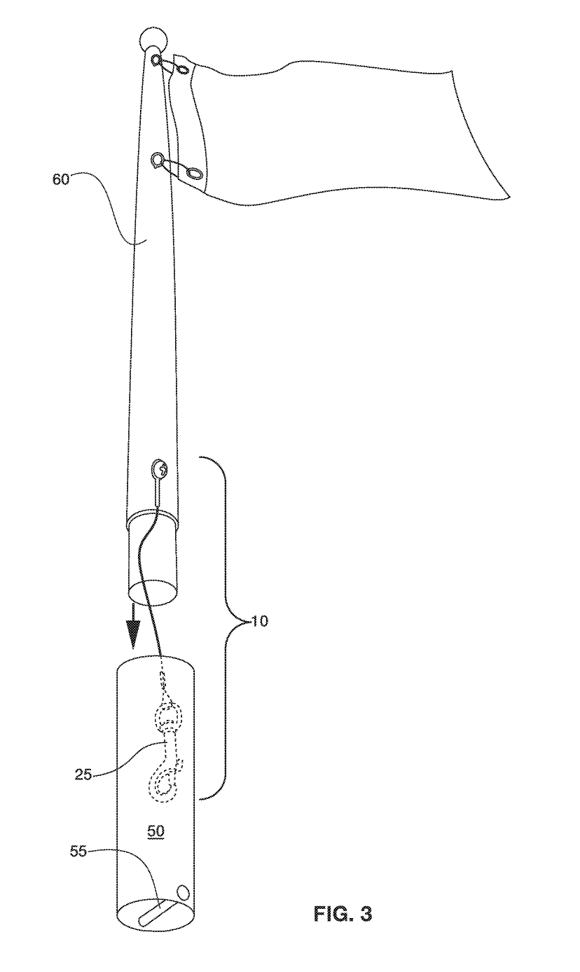

FIG. 3 depicts flag pole 60 with securing device 10 attached thereto that is being inserted into rod holder 50.

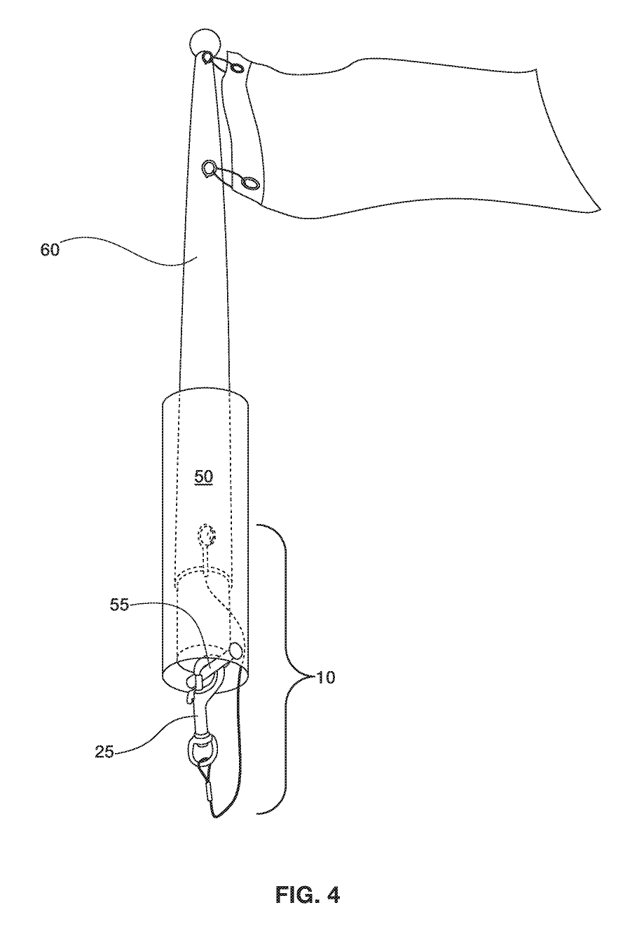

FIG. 4 depicts flag pole 60 inserted into rod holder 50 with device 10 connected to crossbar 55. As can be seen in phantom, bottom end of flag pole 60 abuts crossbar 55.

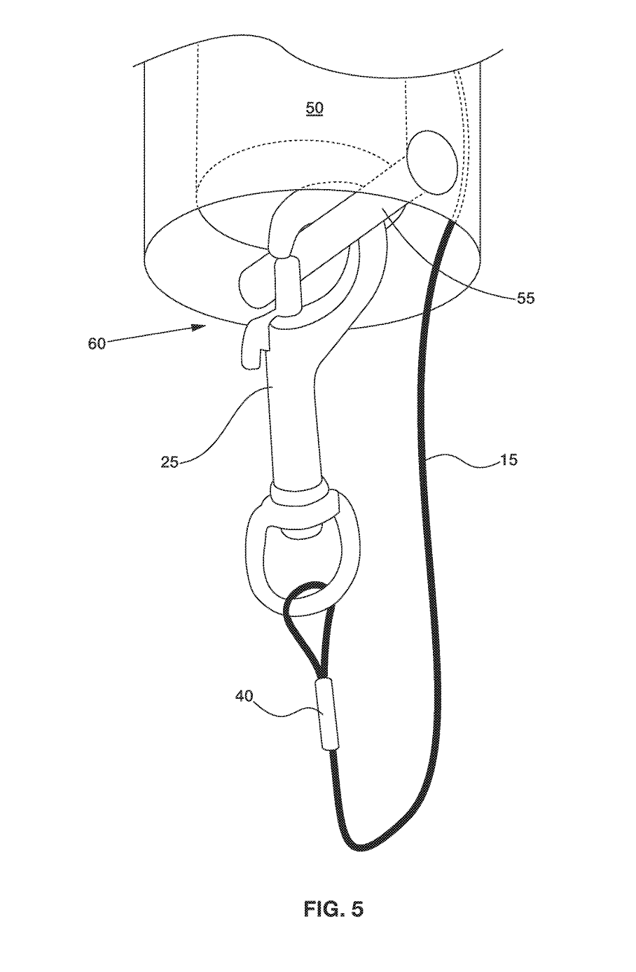

FIG. 5 shows snap hook 25 connected to cross bar 55 in greater detail.

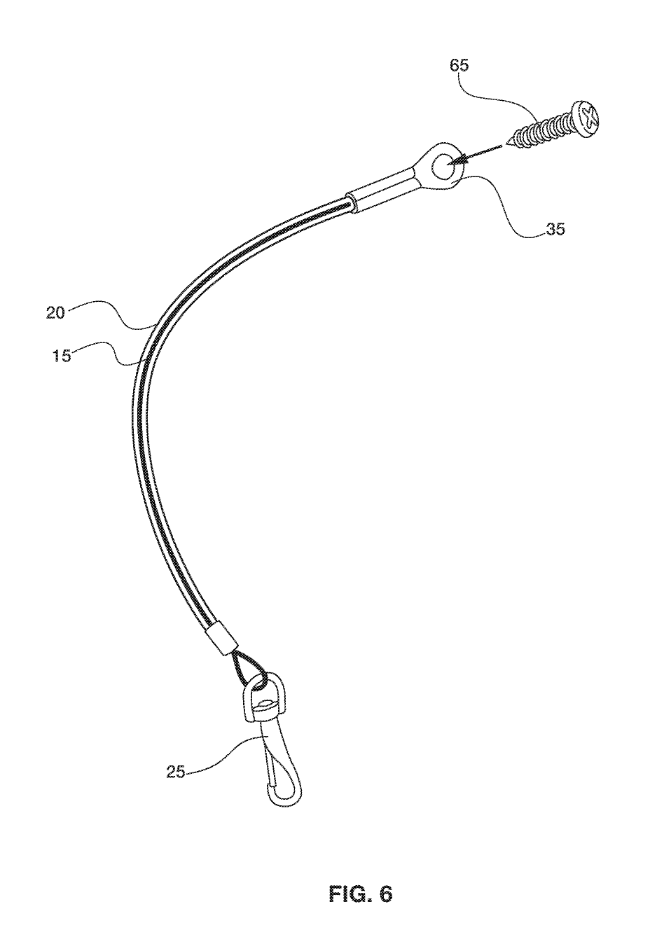

FIG. 6 depicts a preferred embodiment of the present invention including sheathing 20 surrounding cable 15. An alternative snap hook 25 is also shown.

In use, securing device 10 is attached to flag pole 60, as shown in FIG. 2. Bottom end of flag pole 60 is then directed into rod holder 50 with snap hook 25 entering rod holder 50 first, as shown in FIG. 3. Snap hook 25 is then secured to cross bar 55, as shown in FIG. 4. The boat can now be operated with a flying flag.

It should be understood that the foregoing relates to exemplary embodiments of the invention and that modifications may be made without departing from the spirit and scope of the invention as set forth in the following claims. By way of example, the securing device can be used with a variety of rod holders, including those without cross bars, so long as the snap hook can be anchored to a stable structure. It should also be understood that the securing device can be used with a variety of elongated objects which fit into a rod holder, including umbrellas and fishing poles.

Specifications of certain structures and components of the present invention have been established in the process of developing and perfecting prototypes and working models. These specifications are set forth for purposes of describing an embodiment, and setting forth the best mode, but should not be construed as teaching the only possible embodiment. It should be understood that all specifications, unless otherwise stated or contrary to common sense, are +/−10%. It should also be understood that ranges of values set forth inherently include those values, as well as all increments between.

What is claimed is:

1. A device for securing an elongated object within a fishing rod holder, said device including:
A. A section of cable having a first end and a second end;
B. An connecting means at said first end; and
C. A hooking mechanism attached to said second end.

2. The device of claim 1 wherein said cable is surrounded by sheathing.

3. The device of claim 1 wherein said connecting means is an eyelet connector.

4. The device of claim 1 wherein said hooking mechanism is a snap hook.

5. The device of claim 4 wherein said hooking mechanism is a swivel snap hook.

6. A system for securing a flag on a boat including:
A. A fishing rod holder including an upper open end and a lower semi-closed end; and
B. A securing device including a section of cable having a first end with a connecting means, and a second end with a hooking mechanism, said hooking mechanism detachably engaged with said lower semi-closed end.

7. The system of claim 6 wherein said semi-closed end is a cross bar.

8. The system of claim 6 wherein said connecting means comprises an eyelet connector and a screw.

9. The system of claim 6 wherein said hooking mechanism is a snap hook.

10. A method of securing an elongated object within a rod holder including the steps of:
A. Connecting the first end of a securing device to an elongated object;
B. Inserting an unattached end of the securing device into the open end of a rod holder having an upward open end and a downward semi-closed end;
C. Inserting the elongated object into the open end of the rod holder;
D. Protruding the unattached end of the securing device through the semi-closed end; and
E. Connecting the unattached end of the securing device to the semi-closed end.

11. The method of claim 10 wherein said step of connecting the unattached end of the securing device to the semi-closed end includes the step of engaging a snap hook.

12. The method of claim 11 wherein said step of engaging a snap hook includes the step of engaging a snap hook to a cross bar.

13. The method of claim 10 wherein said step of connecting the first end of a securing device to an elongated object includes the step of connecting the first end of a securing device to a flag pole.

14. The method of claim 13 wherein said step of connecting the first end of a securing device to a flag pole includes the step of screwing a screw into the flag pole.

15. The method of claim 10 further including the step of abutting the end of said elongated object against the semi-closed end.
